(19) United States
(12) Patent Application Publication
(10) Pub. No.: US 2025/0348059 A1
(43) Pub. Date: Nov. 13, 2025

(54) METHODS AND SYSTEMS FOR COMBINING STRUCTURAL PERFORMANCE MANAGEMENT TECHNIQUES WITH EXECUTION OF AN ADVANCED PROCESS CONTROL MODULE

(71) Applicant: Akselos S.A., Lausanne (CH)

(72) Inventors: Claus Reimers, Schleswig-Holstein (DE); David John Knezevic, Brookline, MA (US)

(21) Appl. No.: 19/203,459

(22) Filed: May 9, 2025

Related U.S. Application Data
(60) Provisional application No. 63/645,112, filed on May 9, 2024.

(51) Int. Cl. G05B 19/418

(52) U.S. Cl. CPC G05B 19/41845; G05B 19/41865

(57) ABSTRACT

A method for combining structural performance management techniques with execution of an advanced process control module includes reading, by an advanced process control (APC), process data from an asset. The method includes receiving, by a structural integrity analyzer, from the APC module, a request for an update to an asset integrity constraint for the asset. The structural integrity analyzer executes at least one structural analysis technique to compute at least one modification to make to the asset integrity constraint of the asset. The structural integrity analyzer provides, to the APC module, the at least one modification, responsive to the received request. The APC module identifies at least one updated operational setpoint, based upon the at least one modification. The APC module modifies at least one process parameter in a distributed control system to include the identified at least one updated operational setpoint.

### CROSS-REFERENCE TO RELATED APPLICATIONS

This application is a claims priority to U.S. Provisional Patent Application 63/645,112, filed on May 9, 2024, and entitled “Methods and Systems for Combining of Structural Performance Management and Advanced Process Control,” which is hereby incorporated by reference.

### BACKGROUND

The disclosure relates to methods and systems for optimizing the operation of physical assets. More particularly, the methods and systems described herein relate to functionality for combining of structural performance management and advanced process control (APC) modules.

Conventionally, typical APC modules are constrained by process and asset integrity constraints; process constraints include chemistry- and physics-based constraints while asset integrity constraints are typically defined during design of the asset and rarely, if ever, updated during the lifetime of the asset. As a result, conventional solutions typically define constraints narrowly and do not provide functionality for determining whether to modify those constraints during operation of assets or for implementing any modifications. Therefore, there is a need for functionality that can compute asset integrity constraints and update existing constraints, potentially across a plurality of assets.

### BRIEF SUMMARY

In one aspect, a method for combining structural performance management techniques with execution of an advanced process control module includes reading, by an advanced process control (APC), process data from an asset. The method includes receiving, by a structural integrity analyzer, from the APC module, a request for an update to an asset integrity constraint for the asset. The method includes executing, by the structural integrity analyzer, at least one structural analysis technique to compute at least one modification to make to the asset integrity constraint of the asset. The method includes providing, by the structural integrity analyzer, to the APC module, the at least one modification, responsive to the received request. The method includes identifying, by the APC module, at least one updated operational setpoint, based upon the at least one modification. The method includes modifying, by the APC module, at least one process parameter in a distributed control system (DCS) to include the identified at least one updated operational setpoint.

In another aspect, a method for combining SPM techniques with execution of a Real-Time Optimization (RTO) module includes reading, by an RTO module, process data from an asset. The method includes receiving, by a structural integrity analyzer, from the RTO module, a request for an update to an asset integrity constraint for the asset. The method includes executing, by the structural integrity analyzer, at least one structural analysis technique to compute at least one modification to make to the asset integrity constraint of the asset. The method includes providing, by the structural integrity analyzer, to the RTO module, the at least one modification, responsive to the received request. The method includes identifying, by the RTO module, at least one updated operational setpoint, based upon the at least one modification. The method includes modifying, by the RTO module, at least one process parameter in a distributed control system (DCS) to include the identified at least one updated operational setpoint.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram depicting an embodiment of a system for combining of structural performance management (SPM) techniques with execution of an advanced process control (APC) module;

FIG. 1B is a block diagram depicting an embodiment of a system for combining of SPM techniques with execution of an APC module;

FIG. 1C is a block diagram depicting an embodiment of a system for combining of SPM techniques with execution of a real-time optimization (RTO) module;

FIG. 2A is a flow diagram depicting an embodiment of a method for combining of SPM techniques with execution of an APC module;

FIG. 2B is a flow diagram depicting an embodiment of a method for combining of SPM techniques with execution of an RTO module;

FIG. 3A is a flow diagram depicting an embodiment of a method for combining of SPM techniques with execution of an APC module;

FIG. 3B is a flow diagram depicting an embodiment of a method for combining of SPM techniques with execution of an RTO module; and

FIG. 4 is a block diagram depicting a process envelope before and after execution of a method for combining of SPM techniques with execution of an APC module.

### DETAILED DESCRIPTION

The methods and systems described herein may provide functionality for combining of structural performance management (SPM) techniques with execution of advanced process control (APC) modules. The methods and systems described herein may provide functionality for combining of structural performance management (SPM) techniques with Real-Time Optimization (RTO) modules. Such methods and systems may include functionality for process control and optimization.

By way of example and without limitation, industrial plants (such as, for example, petrochemical plants or other chemical plants) may include one or more assets. A plant may include one or more interconnected process units that form a “process.” The individual process units (such as, for example, a reactor) and connecting components (such as, for example, pipes) may be instrumented with sensors to measure key process parameters, such as pressure, temperature, and flowrates. Distributed control systems (DCS) are used to hold the individual process parameters within defined bounds; for example, by automatically adjusting valves, heaters, or pump power. A DCS may include one or more individual controllers that may control individual process units in a plant by, for example, sampling measured data from sensors (controlled variables) and/or adjusting settings on specific devices (e.g., a variable). A DCS may include functionality for changing a setpoint of the DCS within predefined boundaries to move the process in a specific direction. An APC may provide functionality allowing for production of a target product with, for example, maximum throughput and within one or more predetermined specifications. The APC may be in communication with the DCS and interacts with the functionality available in the DCS to move a process in a specific direction by providing values for setpoints for manipulated variables. The APC may automatically control, simultaneously, a group of controllers in a DCS to enhance process stability and/or optimize plant throughput or profit while considering factors such as cost and revenue, functioning as an “autopilot” for one or more process parts in a plant. The APC may define an optimal setpoint for the DCS. The APC may take into account integrity constraints, which are conventionally based on one or more design guidelines and, in many cases, are overconservative.

The overall process behavior is conventionally highly non-linear, resulting in a system in which humans cannot typically develop an end-to-end understanding of the process behavior. Furthermore, a conventional plant may include multiple APCs, which are not typically coordinated across a plant. Individual APCs may optimize different process sections in such a plant, but the sum of those optima does not typically result in a global optimum for the plant as a whole. Some conventional systems attempt to provide global dynamic optimization but do not typically provide functionality for doing so for an entire plant, at most attempting to coordinate APCs across sub-sections of a plant, referred to as envelopes.

However, the methods and systems described herein may provide functionality for computing asset integrity constraints (in real-time or in near real-time) utilizing structural analysis techniques (including, without limitation, Finite Element Analysis (FEA), reduced order modeling approaches including the port-reduced Static Condensation Reduced Basis Element method (SCRBE) and port reduced Nonlinear Reduced Based Element method (NRBE), Artificial intelligence and machine learning (AI/ML) and Scientific Machine Learning (SciML), and so on), allowing for updating of integrity constraints in the APC and/or in an optional global dynamics tool, unlocking additional capacity that was previously-and possibly needlessly-unavailable due to the fixed, unmodifiable nature of previously-specified constraints. By addressing a gap in conventional approaches which do not typically incorporate a real-time view of the structural integrity of one or more pieces of equipment (or components thereof), the methods and systems described herein may safely extend the initial, conservatively chosen, fixed integrity constraints that limit an operating envelope of a plurality of equipment such as, for example, at a plant.

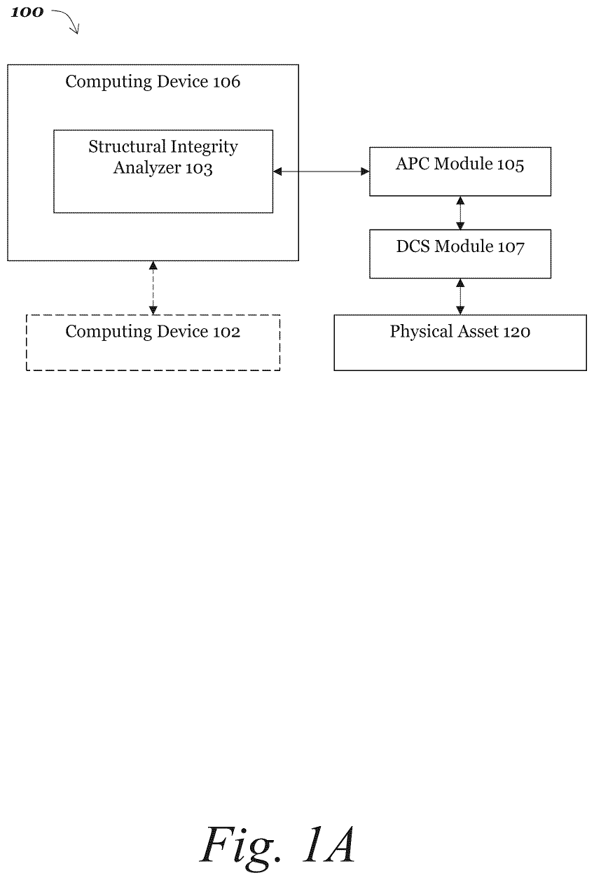

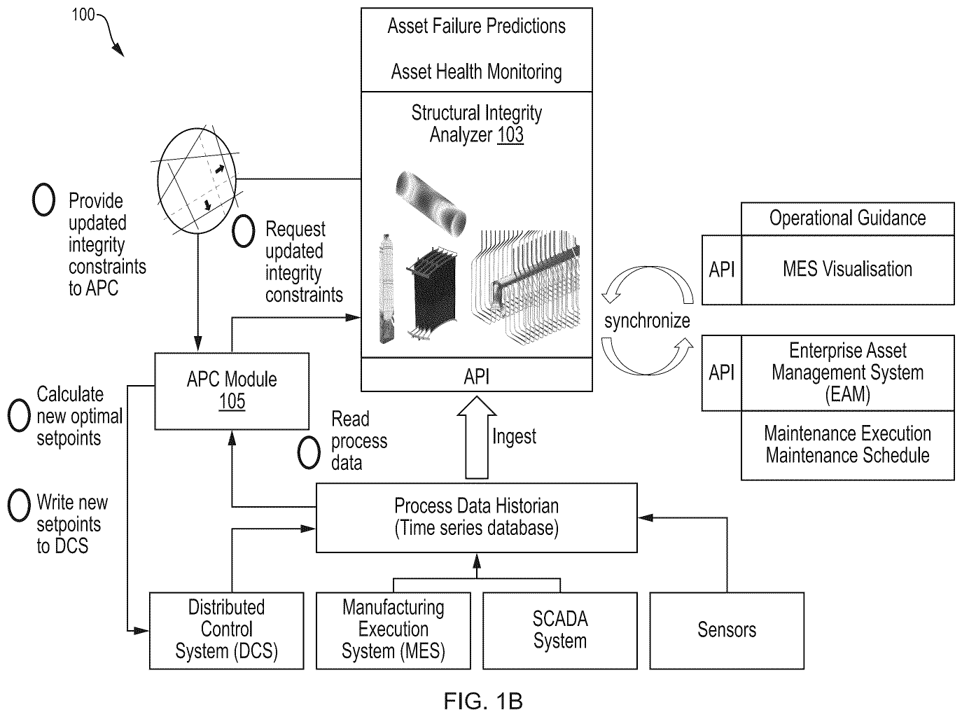

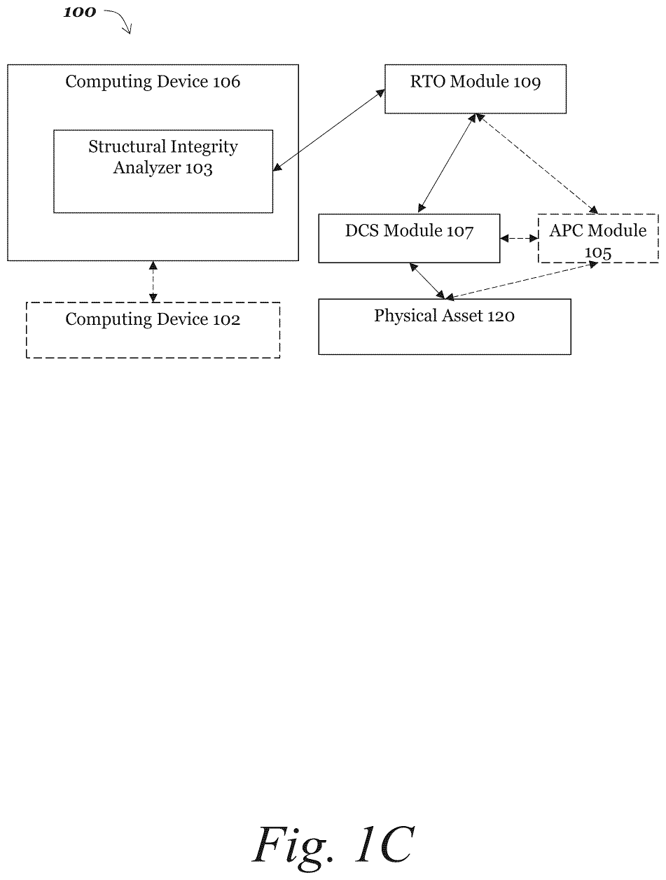

Referring now to FIG. 1A, a block diagram depicts one embodiment of a system 100 for combining of structural performance management techniques with execution of an advanced process control module. The system 100 may execute functionality for computing and modifying asset integrity constraints utilizing structural analysis techniques executed during operation of an asset. In brief overview, the system 100 includes a structural integrity analyzer 103, an APC module 105, a DCS module 107, each of which may execute on one or more modified type or form of computing devices that have been modified to execute instructions for providing the functionality described herein; these modifications result in a new type of computing device that provides a technical solution to problems rooted in computer technology. As depicted in FIG. 1A, the structural integrity analyzer 103 may execute on a computing device 106. The system 100 includes a physical asset 120. The system 100 may optionally include a computing device 102 with which a user of the system may access and interact with the structural integrity analyzer 103 in embodiments in which the user does not directly access the structural integrity analyzer 103.

The structural integrity analyzer 103 may be provided as a software component. The structural integrity analyzer 103 may be provided as a hardware component. One or more computing devices may execute the structural integrity analyzer 103. The structural integrity analyzer 103 may execute at least one structural analysis technique to compute at least one modification to make to an asset integrity constraint of a physical asset 120 to update the asset integrity constraint.

The APC module 105 may be provided as a software component. The APC module 105 may be provided as a hardware component. One or more computing devices may execute the APC module 105. The APC module 105 may be in communication with the structural integrity analyzer 103. The APC module 105 may be in communication with the DCS module 107. The APC module 105 may receive an identification of the at least one modification to make to the asset integrity constraint of the physical asset 120. The APC module 105 may identify an updated operational setpoint, based upon the received identification of the at least one modification. The APC module 105 may modify at least one process parameter in a distributed control system to include the updated operational setpoint.

The DCS module 107 may be provided as a software component. The DCS module 107 may be provided as a hardware component. One or more computing devices may execute the DCS module 107.

Referring now to FIG. 1B, a block diagram depicts one embodiment of the system 100. As shown in FIG. 1B, in addition to the DCS module 107, the system 100 may include a manufacturing execution system (MES) and a MES visualization module, an enterprise asset management system (EAM), a maintenance execution maintenance schedule, one or more sensors associated with one or more assets, a process data historian providing access to a time series database, and a Supervisory Control and Data Acquisition System (SCADA) (which may, for example, collect real-time data from the one or more sensors and the one or more assets).

Referring now to FIG. 1C, block diagram depicts one embodiment of the system 100. As shown in FIG. 1C, the system 100 may include a real-time optimization (RTO) module 109. The RTO module 109 may be provided in addition to the APC module 105. The RTO module 109 may be provided instead of the APC module 105. The RTO module 109 may be in communication with the structural integrity analyzer 103. The RTO module 109 may be in communication with the DCS module 107. The RTO module 109 may identify an updated operational setpoint, based upon the received identification of the at least one modification. The RTO module 109 may modify at least one process parameter in a distributed control system to include the updated operational setpoint. As will be understood by those of skill in the art, the RTO may provide a higher level optimization layer that continuously adjusts process setpoints to maximize the likelihood of achieving one or more operating targets within one or more assets (e.g., within a plant).

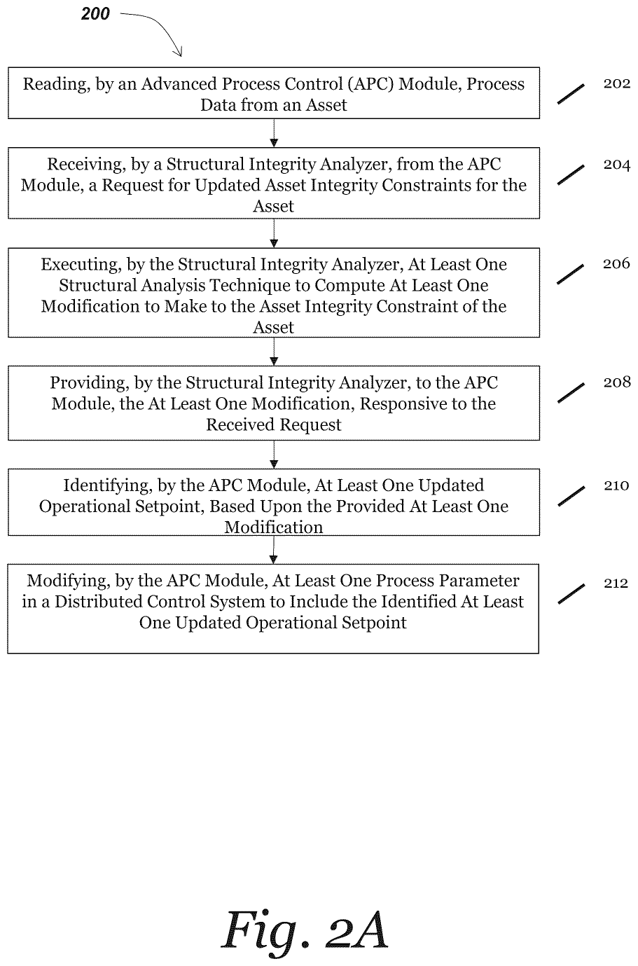

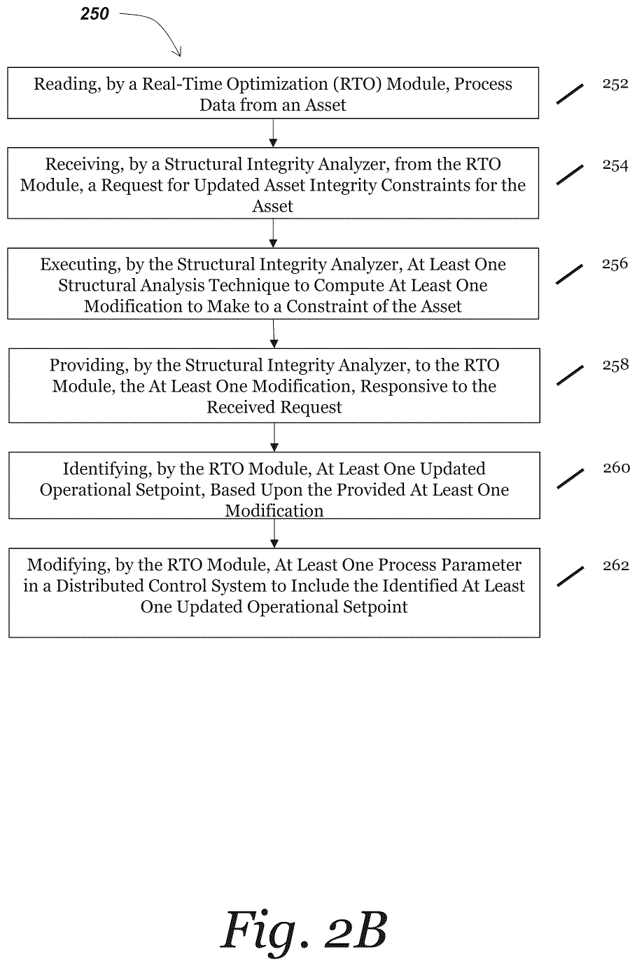

Referring now to FIG. 2A, in brief overview, a method 200 for combining SPM techniques with execution of an APC module may include reading, by an APC module, process data from an asset (202). The method 200 may include receiving, by a structural integrity analyzer, from the APC module, a request for an update to an asset integrity constraint for the asset (204). The method 200 may include executing, by the structural integrity analyzer, at least one structural analysis technique to compute at least one modification to make to the asset integrity constraint of the asset (206). The method 200 may include providing, by the structure integrity analyzer, to the APC module, the at least one modification, responsive to the received request (208). The method 200 may include identifying, by the APC module, at least one updated operational setpoint, based upon the provided at least one modification (210). The method 200 may include modifying, by the APC module, at least one process parameter in a DCS to include the identified at least one updated operational setpoint (212).

Referring now to FIG. 2A in greater detail, and in connection with FIGS. 1A-1C, the method 200 for combining SPM techniques with execution of an APC module may include reading, by an APC module, process data from an asset (202). Process data may include data that can be used in structural analysis such as, without limitation, data related to pressures, and temperatures (e.g., these assets have fluids flowing into them and out of them and the temperatures and pressures of these fluids can be monitored as “process data”), which the system may also use in the execution of one or more structural integrity analyses.

The method 200 may include receiving, by a structural integrity analyzer, from the APC module, a request for an update to an asset integrity constraint for the asset (204). The APC module 105 may transmit the request via an application programming interface (API).

The method 200 may include receiving, by the structural integrity analyzer 103, data associated with the asset from a time series database. The method 200 may include receiving, by the structural integrity analyzer, data associated with the asset from a SCADA system. The method 200 may include receiving, by the structural integrity analyzer 103, data associated with the asset from a Manufacturing Execution System (MES). The method 200 may include receiving, by the structural integrity analyzer 103, data associated with the asset from the DCS. The method 200 may include receiving, by the structural integrity analyzer 103, data associated with the asset from a time series database.

The method 200 may include executing, by the structural integrity analyzer, at least one structural analysis technique to compute at least one modification to make to the asset integrity constraint of the asset (206). The structural integrity analyzer 103 may use any of the data received from the other components in the system 100 in executing the at least one structural analysis technique. The structural integrity analyzer 103 may execute the at least one structural analysis technique. The structural integrity analyzer 103 may execute a component-based reduced order modeling method. The structural integrity analyzer 103 may execute a full order method. The structural integrity analyzer 103 may execute a machine learning engine to execute the at least one structural analysis technique. The structural integrity analyzer 103 may analyze a level of integrity of the asset, or of a component of the asset, responsive to executing the at least one structural analysis technique.

The method 200 may include providing, by the structural integrity analyzer, to the APC module, the at least one modification, responsive to the received request (208). The structural integrity analyzer 103 may transmit the at least one modification to the APC module via, for example, an applications programming interface (API). The structural integrity analyzer 103 may transmit an identification of an updated integrity constraint to which to set at least one process parameter. The structural integrity analyzer 103 may transmit data with which the APC module may calculate the updated asset integrity constraint.

The method 200 may include identifying, by the APC module, at least one updated operational setpoint, based upon the provided at least one modification (210). The APC module 105 may calculate an updated operational setpoint using the updated integrity constraint received from the structural integrity analyzer 103. The APC module 105 may receive the updated operational setpoint.

The method 200 may include modifying, by the APC module, at least one process parameter in a DCS to include the identified at least one updated operational setpoint (212). Modifying the at least one process parameter may result in modifying a manner in which the asset is operated.

The method may include updating, by the structural integrity analyzer 103, a manufacturing execution system (MES) visualization of one or more assets. The method may include updating, by the structural integrity analyzer 103, an enterprise asset management system (EAM). The method may include updating, by the structural integrity analyzer, a maintenance execution schedule maintained by the EAM based upon the identified at least one updated operational setpoint and/or the at least one modification. The method may include updating, by the structural integrity analyzer, a maintenance schedule maintained by the EAM, based upon the identified at least one updated operational setpoint and/or the at least one modification. By providing functionality for analyzing, substantially in real-time or near real-time, asset integrity and determining whether and how to modify constraints on asset integrity and automatically implementing such a modification, the methods and systems described herein provide functionality for providing real-time structural integrity insights to improve asset performance, ensure uninterrupted operations, and extend a lifetime of the asset.

In some embodiments, the method 200 includes executing, by the structural integrity analyzer 103, a second at least one structural analysis technique to compute a modification to make to a second asset integrity constraint to update a second asset integrity constraint of a second asset (or component of an asset), responsive to identifying, by the APC module, the at least one updated operational setpoint; providing, by the structural integrity analyzer, to a second APC module, the modification to the second asset integrity constraint; identifying, by the second APC module, a second updated operational setpoint for the second asset, based upon the modification to the second asset integrity constraint; and modifying, by the second APC module, a second process parameter in the DCS to include the identified second updated operational setpoint. By way of example, and without limitation, in a plant having a plurality of APC modules, each APC module may optimize a different section of the plant. Unlike in conventional systems in which those separate APC modules do not coordinate and only find a local optimum (and in which the sum of those optima is typically not a global optimum for the plant overall), the execution of the methods and systems described herein allows for coordination between different APC modules to find a global optima. This may be done in some embodiments for an entire plant. This may be done in other embodiments for a section of the plant, which may be referred to as an envelope. An identification of a determination to define a setpoint or to modify a process parameter by one APC module may be transmitted to a global dynamic optimization unit, which may determine a global optimum for a defined envelop or other operating area; in such embodiments, one APC may modify a process parameter based on a change made by another APC.

In some embodiments, instead of, or in addition to, the structural integrity analyzer receiving the request from the APC, the structural integrity analyzer 103 may receive the request from the RTO module 109. Referring now to FIG. 2B, in brief overview, a method 250 for combining SPM techniques with execution of an RTO module may include reading, by an RTO module, process data from an asset (252). The method 250 may include receiving, by a structural integrity analyzer, from the RTO module, a request for an update to an asset integrity constraint for the asset (254). The method 250 may include executing, by the structural integrity analyzer, at least one structural analysis technique to compute at least one modification to make to the asset integrity constraint of the asset (256). The method 250 may include providing, by the structure integrity analyzer, to the RTO module, the at least one modification, responsive to the received request (258). The method 250 may include identifying, by the RTO module, at least one updated operational setpoint, based upon the provided at least one modification (260). The method 250 may include modifying, by the RTO module, at least one process parameter in a DCS to include the identified at least one updated operational setpoint (262).

Referring now to FIG. 2B in greater detail, and in connection with FIGS. 1A-1C, the method 250 for combining SPM techniques with execution of an APC module may include reading, by an RTO module, process data from an asset (252). The reading may occur as described above in connection with FIG. 2A.

The method 250 may include receiving, by a structural integrity analyzer, from the RTO module, a request for an update to an asset integrity constraint for the asset (254). The receiving may occur as described above in connection with FIG. 2A.

The method 250 may include executing, by the structural integrity analyzer, at least one structural analysis technique to compute at least one modification to make to the asset integrity constraint of the asset (256). The executing may occur as described above in connection with FIG. 2A.

The method 250 may include providing, by the structure integrity analyzer, to the RTO module, the at least one modification, responsive to the received request (258). The providing may occur as described above in connection with FIG. 2A.

The method 250 may include identifying, by the RTO module, at least one updated operational setpoint, based upon the provided at least one modification (260). The identifying may occur as described above in connection with FIG. 2A.

The method 250 may include modifying, by the RTO module, at least one process parameter in a DCS to include the identified at least one updated operational setpoint (262). The modifying may occur as described above in connection with FIG. 2A.

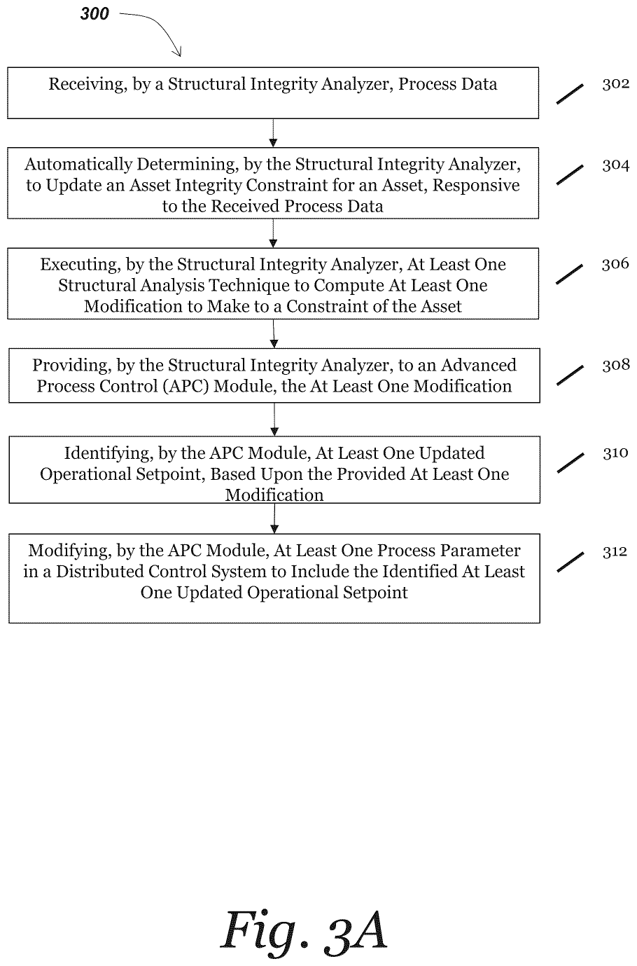

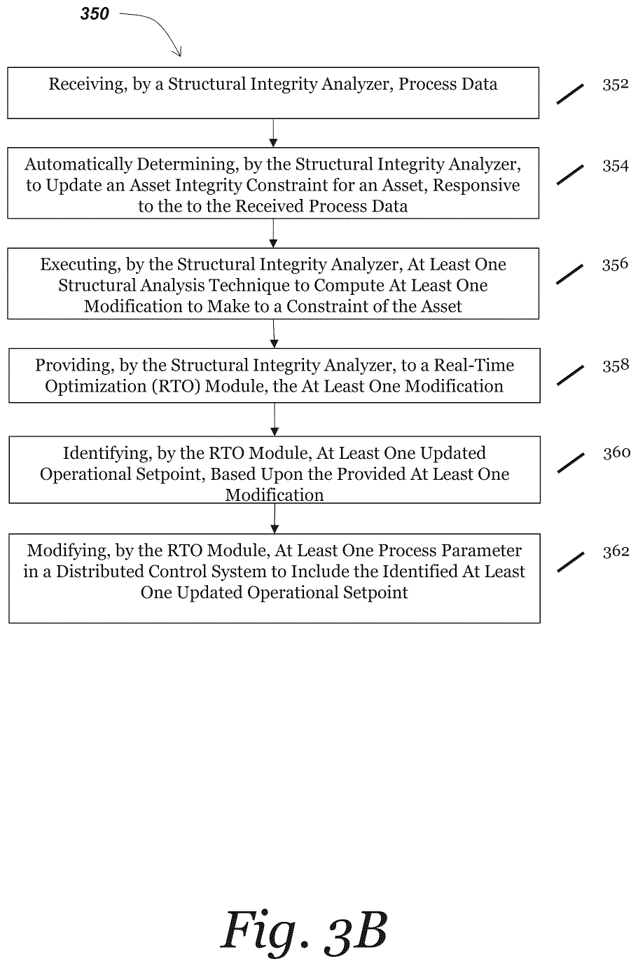

In some embodiments, instead of, or in addition to, the structural integrity analyzer 103 receiving the request from the APC module 105, the structural integrity analyzer 103 may send asset integrity constraint updates whenever an update is available. In such embodiments, the APC module 105 may determine that constraints are unchanged until it receives an update from the structural integrity analyzer 103. Referring to FIG. 3A, a method 300 for combining SPM techniques with execution of an APC module includes receiving, by a structural integrity analyzer, process data (302). The method 300 includes automatically determining, by the structural integrity analyzer, to update an asset integrity constraint for an asset, responsive to the received process data (304). The method 300 includes executing, by the structural integrity analyzer, at least one structural analysis technique to compute at least one modification to make to the asset integrity constraint of the asset (306). The method 300 includes providing, by the structural integrity analyzer, to an APC module, the at least one modification (308). The method 300 includes identifying, by the APC module, at least one updated operational setpoint, based upon the at least one modification (310). The method 300 includes modifying, by the APC module, at least one process parameter in a distributed control system to include the identified at least one updated operational setpoint (312).

Referring to FIG. 3A in greater detail, and in connection with FIGS. 1A-2B, a method 300 for combining SPM techniques with execution of an APC module includes receiving, by a structural integrity analyzer, process data (302). The structural integrity analyzer 103 may receive the process data from a process data historian (as shown in FIG. 1B).

The method 300 includes automatically determining, by the structural integrity analyzer, to update an asset integrity constraint for an asset, responsive to the received process data (304). The structural integrity analyzer 103 may send asset integrity constraint updates whenever an update is available. In such embodiments, the APC module 105 may determine that constraints are unchanged until it receives an update from the structural integrity analyzer 103.

The method 300 includes executing, by the structural integrity analyzer, at least one structural analysis technique to compute at least one modification to make to the asset integrity constraint of the asset (306). The executing may occur as described above in connection with FIG. 2A.

The method 300 includes providing, by the structural integrity analyzer, to an APC module, the at least one modification (308). The providing may occur as described above in connection with FIG. 2A.

The method 300 includes identifying, by the APC module, at least one updated operational setpoint, based upon the at least one modification (310). The identifying may occur as described above in connection with FIG. 2A.

The method 300 includes modifying, by the APC module, at least one process parameter in a distributed control system to include the identified at least one updated operational setpoint (312). The modification may occur as described above in connection with FIG. 2A.

Similarly, and referring to FIG. 3B, a method 350 for combining SPM techniques with execution of an RTO module includes receiving, by a structural integrity analyzer, process data (352). The method 350 includes automatically determining, by the structural integrity analyzer, to update an asset integrity constraint for an asset, responsive to the received process data (354). The method 350 includes executing, by the structural integrity analyzer, at least one structural analysis technique to compute at least one modification to make to the asset integrity constraint of the asset (356). The method 350 includes providing, by the structural integrity analyzer, to an RTO module, the at least one modification (358). The method 350 includes identifying, by the RTO module, at least one updated operational setpoint, based upon the at least one modification (360). The method 350 includes modifying, by the RTO module, at least one process parameter in a distributed control system to include the identified at least one updated operational setpoint (362).

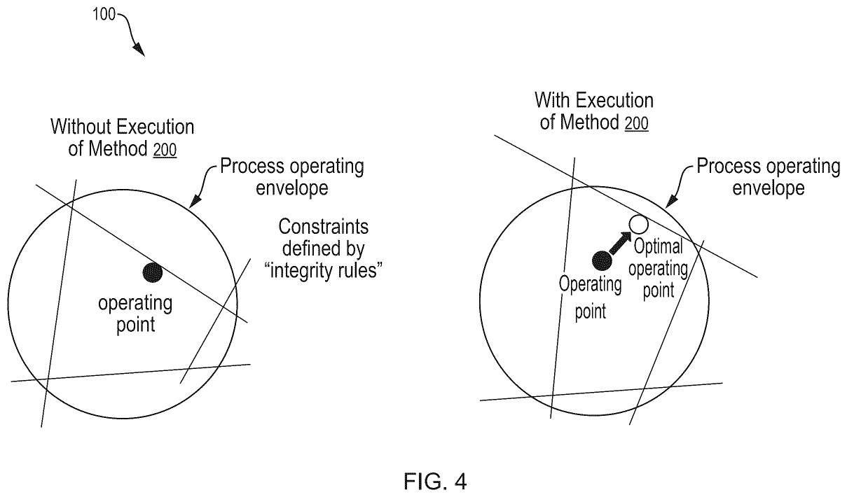

Referring now to FIG. 4, a block diagram depicts a process envelope before and after execution of a method for combining of SPM techniques with execution of an APC module. A process may be operated safely within a process envelope (e.g., a multi-dimensional space described by process parameters), the setpoints in the DCS may be modified to move the process into operating at a particular operating point (e.g., by defining sets of values for specific process parameters), and this “operating envelop” is constrained by process and asset integrity constraints; often, the optimal operating point is determined to be at a specific constraint. By executing the methods and systems described herein, the system may update constraints during operation of an asset, which results in a modification to an optimal operating point, enabling the use of previously unused or underutilized plant capacity. As depicted in FIG. 4, without execution of the methods and systems described herein, the operating envelope on the left is shown to operate at a particular fixed point set by constraints but with the execution of the methods and systems described herein, the operating point may be varied to operate within an optimal operating point that is variable.

As indicated above, the methods and systems described herein may provide functionality for performing structural integrity monitoring and reassessment during operation, which may enable identification of extra capacity present in the asset (and hence may avoid early decommissioning) or overly onerous maintenance regimes, while also tracking the impact of extreme or unpredictable events to ensure safety and reliability. In some embodiments, this goal of asset tracking and integrity monitoring during operations motivates the concept of a structural digital twin. The term digital twin may refer to a computational model or replica of a physical asset which is kept in sync with the asset during its operational lifetime, based on inspection and sensor data, for example. A structural digital twin may refer to the specific case in which the purpose of the digital twin is to assess structural integrity based on the “as is” state of the asset. Updates to a structural digital twin may capture any structurally relevant changes to the asset, and can be based on, for example, inspection data (e.g. visual inspection, ultrasound thickness measurements, laser scans) or sensor measurements (e.g. accelerometers, strain gauges, environmental monitoring). This inspection and instrumentation significantly reduces, if not eliminates, the uncertainty associated with operating conditions since it allows for continuous updates the digital twin to reflect the true state of the asset and its environment. Through this approach, users of the methods and systems described herein may therefore develop updated asset management plans informed by the structural digital twin (e.g. for inspection, maintenance, repair, changes to allowable operating conditions, damage or accident response, or asset life extension) instead of relying on the plans that were developed at design-time. Furthermore, it should be noted that structural digital twins may be provided for physical assets within industrial systems, such as fixed or floating offshore structures, aircraft, mining machinery, rotating machinery, or pressure vessels. The methods and systems described herein, therefore, include a component-based reduced order modeling framework based on the Static Condensation Reduced Basis Element (SCRBE) method that enables fast, holistic, detailed, and parametric structural analysis of large-scale industrial systems. This methodology supports modeling needs of structural digital twins, where a structural digital twin is a detailed physics-based model of a structural system that tracks the “as is” state of the system over its operational lifetime. A range of numerical examples will be discussed in further detail below that illustrate the unique capabilities of the SCRBE approach to incorporate inspection and/or sensor data, efficiently perform detailed structural integrity analysis, and enable post-processing and report generation to support data-driven decision-making during operation of critical structural systems.

One tool for structural integrity analysis of industrial equipment is the Finite Element (FE) method. FE certainly satisfies requirements around standards compliance and certifiable accuracy, but it has significant limitations for the other three items. Regarding holistic and detailed modeling and speed, the computational speed and memory requirements of FE typically grow superlinearly with the number of degrees of freedom, and hence in most practical circumstances detailed and holistic modeling is not feasible for large-scale systems with FE. This issue with FE has led to the development of many submodeling-based workflows (coarse global models and separate fine local models), but the submodeling approach ignores the non-local and cumulative effects we aim to capture when performing an update to a structural digital twin. Regarding parametric modeling, FE is not inherently parametric, in the sense that any parametric change requires a new (often computationally intensive) solve to be performed from scratch.

Artificial intelligence and machine learning (AI/ML), and related methods such as response surfaces, are another set of candidate methodologies that are often promoted for digital twins. AI/ML enables fast analysis of systems, typically by evaluating specific quantities of interest (QoIs) as a function of parameters. As a result, AI/ML covers items speed and parametric modeling well, but it falls short on the remaining two items. For holistic and detailed modeling, evaluation of specific quantities of interest is not consistent with the concept of a holistic and detailed model in which all details of an asset should be fully represented, since the specific QoI outputs do not provide a picture of the entire asset. For standards compliance and certifiable accuracy, AI/ML models are well-known to be “black boxes” which are difficult to interpret, and which are not based on first principles of physics or compliant with physics-based asset integrity standards.

There is a wide range of reduced order modeling (ROM) methods that have been developed and which could be candidates for the type of structural digital twin discussed above, including Parabolic Orthogonal Decomposition (POD), Proper Generalized Decomposition (PGD), or Certified Reduced Basis Method; ROMs certainly provide speed, and-depending on the ROM type-may also provide parametric modeling and certifiable accuracy. Note that the term “Reduced Order Method” is in contrast to a so-called “full order method”, such as the finite element method, since no reduction is applied in the context of a full order method. However, the ROMs generally do not enable holistic and detailed modeling of large-scale systems; therefore, they do not typically provide a methodology that will apply to the largest industrial systems, e.g. equivalent to more than 10⁸ FE degrees of freedom, as required for fully detailed models of large-scale floating structures, or aircraft, for example. The ROM approaches mentioned above are not well-suited to this type of large-scale model, since ROMs need to be “trained” by solving the full order model many times for different configurations, and this is prohibitively expensive when the full-order model is very large-scale.

Therefore, the methods and systems described herein may leverage a component-based ROM approach based on the Static Condensation Reduced Basis Element (SCRBE) framework. The SCRBE methodology builds on the Certified Reduced Basis Method to provide a physics-based ROM of parametric partial differential equations (PDEs). As is typical for ROM approaches, SCRBE involves an Offline/Online decomposition in which the model data is “trained” during the Offline stage, and subsequently evaluated for specific parameter choices during the Online stage. The Offline stage is computationally intensive, but once it is complete the Online stage may be evaluated very quickly (typically orders of magnitude faster than a corresponding FE solve) for any new parameter choices within a pre-defined range. The key aspect of the methodology that differentiates it from the ROM methods discussed above, however, is that it is component-based, in the sense that the overall system is decomposed into smaller components and a separate ROM is trained for each component. This enables greater scalability than other approaches since with SCRBE the system does not need to solve the entire system with a full order (e.g. FE) solver during the Offline stage—it is sufficient to solve isolated components and local subsystems in order to generate the training data. The resulting ROM for each component consists of reduced order representations of both the component interior (via the standard Reduced Basis method) and the component interfaces via “port reduction”. The baseline SCRBE method applies to linear PDEs since the formulation leverages static condensation, but it can be naturally extended to incorporate nonlinearities by including nonlinear FE regions in the model where needed. Such a SCRBE framework addresses the properties of structural digital twins described above. The term “SCRBE” may be generalized to the Nonlinear Reduced Basis Element (NRBE) method by applying nonlinear Reduced Basis approximations on each component, and omitting the “static condensation” step from SCRBE. This provides the same advantages (with some extra computational cost due to nonlinearities) as the SCRBE framework. The term “RBE method” as used herein refers to either the SCRBE or the NRBE methods.

While the methods and systems described herein may leverage the RBE methodology, in some embodiments, these methods and systems are combined with functionality for RBE, FE, and/or AI/ML. Therefore, the methods described herein may include receiving output from an AI/ML system and incorporating that output into the analyses; such methods may include providing output back to the AI/ML system with which the AI/ML system may automatically improve its subsequent execution. In particular, AI/ML may be highly effective as a “canary” in that it can generate a potential “red flag” quickly based on specific QoIs during operations, and then RBE may be applied for a fully-detailed analysis to assess the red flag scenario in more detail and prescribe further action if needed. Another combination of RBE and AI/ML uses RBE to generate physics-based data that can be used to augment real-world measurements, and then the augmented datasets can be used to train a richer AI/ML model. This is particularly important in order to enable an AI/ML model to accurately classify rare behavior (such as failures, which are typically rare on well-managed assets) since the real-world datasets on rare events is by definition limited. To address this issue, physics-based ROMs such as RBE can be used to efficiently generate a wide range of failure mode data by simulating specific failure scenarios and extracting virtual sensor readings in order to augment and enrich AI/ML training sets. Similarly, RBE and FE complement each other well since RBE enables fast and parametric modeling of large-scale systems, which can be used to identify localized regions in the system which may have structural integrity issues. Once a region is identified, it can be subjected to extensive localized FE analysis to perform further assessment—and since RBE is based on FE meshes, the system may run FE using any subset of the components in an RBE model.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIG. 1.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

Although terms such as “optimize” and “optimal” may be used herein, in practice, embodiments of the present invention may include methods which produce outputs that are not optimal, or which are not known to be optimal, but which nevertheless are useful. For example, embodiments of the present invention may produce an output which approximates an optimal solution, within some degree of error. As a result, terms herein such as “optimize” and “optimal” should be understood to refer not only to processes which produce optimal outputs, but also processes which produce outputs that approximate an optimal solution, within some degree of error.

The terms “A or B”, “at least one of A or/and B”, “at least one of A and B”, “at least one of A or B”, or “one or more of A or/and B” used in the various embodiments of the present disclosure include any and all combinations of words enumerated with it. For example, “A or B”, “at least one of A and B” or “at least one of A or B” may mean (1) including at least one A, (2) including at least one B, (3) including either A or B, or (4) including both at least one A and at least one B.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, Python, Rust, Go, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Having described certain embodiments of methods and systems for combining structural performance management (SPM) techniques with execution of an advanced process control module, it will now become apparent to one of skill in the art that other embodiments incorporating the concepts of the disclosure may be used. Therefore, the disclosure should not be limited to certain embodiments but rather should be limited only by the spirit and scope of the following claims.

What is claimed is:

1. A method for combining structural performance management techniques with execution of an advanced process control module, the method comprising:
reading, by an advanced process control (APC) module, process data from an asset;
receiving, by a structural integrity analyzer, from the APC module, a request for an update to an asset integrity constraint for the asset;
executing, by the structural integrity analyzer, at least one structural analysis technique to compute at least one modification to make to the asset integrity constraint of the asset;
providing, by the structural integrity analyzer, to the APC module, the at least one modification, responsive to the received request;
identifying, by the APC module, at least one updated operational setpoint, based upon the at least one modification; and
modifying, by the APC module, at least one process parameter in a distributed control system (DCS) to include the identified at least one updated operational setpoint.

2. The method of claim 1 further comprising analyzing, by the structural integrity analyzer, a level of integrity of the asset responsive to executing the at least one structural analysis technique.

3. The method of claim 1, wherein executing, by the structural integrity analyzer, at least one structural analysis technique, further comprises executing a component-based reduced order modeling method.

4. The method of claim 1, wherein executing, by the structural integrity analyzer, at least one structural analysis technique, further comprises executing a full order method.

5. The method of claim 1, wherein executing, by the structural integrity analyzer, at least one structural analysis technique, further comprises executing a machine learning engine to execute the at least one structural analysis technique.

6. The method of claim 1, wherein modifying, by the APC module, the at least one process parameter in the DCS further comprises modifying a manner in which the asset is operated.

7. The method of claim 1 further comprising updating, by the structural integrity analyzer, after modification of the at least one process parameter in the DCS, a visualization of one or more assets within a manufacturing execution system.

8. The method of claim 1 further comprising updating, by the structural integrity analyzer, an enterprise asset management system.

9. The method of claim 1 further comprising:
executing, by the structural integrity analyzer, a second at least one structural analysis technique to compute a modification to make to a second asset integrity constraint to update a second asset integrity constraint of a second asset, responsive to identifying, by the APC module, the at least one updated operational setpoint;
providing, by the structural integrity analyzer, to a second APC module, the modification to the second asset integrity constraint;
identifying, by the second APC module, a second updated operational setpoint for the second asset, based upon the modification to the second asset integrity constraint; and
modifying, by the second APC module, a second process parameter in the DCS to include the identified second updated operational setpoint.

10. A method for combining structural performance management techniques with execution of a real-time optimization module, the method comprising:
reading, by a real-time optimization (RTO) module, process data from an asset;
receiving, by a structural integrity analyzer, from the RTO module, a request for an update to an asset integrity constraint for the asset;
executing, by the structural integrity analyzer, at least one structural analysis technique to compute at least one modification to make to the asset integrity constraint of the asset;
providing, by the structural integrity analyzer, to the RTO module, the at least one modification, responsive to the received request;
identifying, by the RTO module, at least one updated operational setpoint, based upon the at least one modification; and
modifying, by the RTO module, at least one process parameter in a distributed control system (DCS) to include the identified at least one updated operational setpoint.

11. The method of claim 10 further comprising analyzing, by the structural integrity analyzer, in real-time, a level of integrity of the asset responsive to executing the at least one structural analysis technique.

12. The method of claim 10, wherein executing, by the structural integrity analyzer, at least one structural analysis technique, further comprises executing a component-based reduced order modeling method.

13. The method of claim 10, wherein executing, by the structural integrity analyzer, at least one structural analysis technique, further comprises executing a full order method.

14. The method of claim 10, wherein executing, by the structural integrity analyzer, at least one structural analysis technique, further comprises executing a machine learning engine to execute the at least one structural analysis technique.

15. The method of claim 10, wherein modifying, by the RTO module, the at least one process parameter in the DCS further comprises modifying a manner in which the asset is operated.

16. The method of claim 10 further comprising updating, by the structural integrity analyzer, after modification of the at least one process parameter in the DCS, a visualization of one or more assets within a manufacturing execution system.

17. The method of claim 10 further comprising updating, by the structural integrity analyzer, an enterprise asset management system.

18. The method of claim 10 further comprising:
executing, by the structural integrity analyzer, a second at least one structural analysis technique to compute a modification to make to a second asset integrity constraint to update a second asset integrity constraint of a second asset, responsive to identifying, by the RTO module, the at least one updated operational setpoint;
providing, by the structural integrity analyzer, to a second APC module, the modification to the second asset integrity constraint;
identifying, by the second RTO module, a second updated operational setpoint for the second asset, based upon the modification to the second asset integrity constraint; and
modifying, by the second RTO module, a second process parameter in the DCS to include the identified second updated operational setpoint.

19. A method for combining structural performance management techniques with execution of an advanced process control module, the method comprising:
receiving, by a structural integrity analyzer, process data;
automatically determining, by the structural integrity analyzer, to update an asset integrity constraint for an asset, responsive to the received process data;
executing, by the structural integrity analyzer, at least one structural analysis technique to compute at least one modification to make to the asset integrity constraint of the asset;
providing, by the structural integrity analyzer, to an advanced process control (APC) module, the at least one modification;
identifying, by the APC module, at least one updated operational setpoint, based upon the at least one modification; and
modifying, by the APC module, at least one process parameter in a distributed control system to include the identified at least one updated operational setpoint.

20. The method of claim 19 further comprising:
executing, by the structural integrity analyzer, a second at least one structural analysis technique to compute a modification to make to a second asset integrity constraint to update a second asset integrity constraint of a second asset, responsive to identifying, by the APC module, the at least one updated operational setpoint;
providing, by the structural integrity analyzer, to a second APC module, the modification to the second asset integrity constraint;
identifying, by the second APC module, a second updated operational setpoint for the second asset, based upon the modification to the second asset integrity constraint; and
modifying, by the second APC module, a second process parameter in the DCS to include the identified second updated operational setpoint.
